(19) United States
(12) Patent Application Publication
(10) Pub. No.: US 2011/0273054 A1
(43) Pub. Date: Nov. 10, 2011

(54) ELECTRICAL STEEL, A MOTOR, AND A METHOD FOR MANUFACTURE OF ELECTRICAL STEEL WITH HIGH STRENGTH AND LOW ELECTRICAL LOSSES

(76) Inventor: Gwynne Johnston, Barrington Hills, IL (US)

(21) Appl. No.: 12/773,042

(22) Filed: May 4, 2010

(51) Int. Cl. H02K 1/02; B22D 11/10; C22C 38/00; C22C 38/42; C22C 38/02; H02K 15/00; B22D 11/12

(52) U.S. Cl. 310/216.004; 29/596; 164/473; 164/476; 420/91; 420/87

(57) ABSTRACT

In a method for manufacture of electrical steel a liquid steel mixture is created with a specified mixture chemistry. A continuous casting is performed to convert the liquid steel mixture to a slab. Hot roll steel band is created from the slab which is then pickled and hot band annealed, and then a cold rolled steel strip is formed. In a continuous annealing line, the cold rolled strip is annealed to achieve a partial recrystallization with a smaller grain size than would be the grain size with a complete recrystallization. Electrical steel created by the method is used for rotors and matching stators of a motor with properties at high strength and low electrical losses.

### BACKGROUND

### Introduction

The development of new electrical motors, especially hybrid electric motors for use in Electric vehicles and Hybrid electric vehicles, requires that the rotor of the motor operate at very high speeds (RPM). This is especially true for rotors developed using permanent magnets. The performance of this type of motor provides maximum torque and efficiency at high RPM. However, the design conditions for this situation of very high speed require that the steel component of the rotor, in the form of electrical steel laminations, should have a high yield strength to resist the resulting high centrifugal forces (from the high RPM). The property of high yield strength is an additional property for the electrical steels used for these motors since the normal requirement is to select the steel grade based only on the electrical losses. One of the characteristics of this type of hybrid motor is that the operating frequencies are high, typically above 400 Hertz. As a result, the electrical losses increase dramatically (the losses increase to the power or exponent of approximately 1.6, as described by the Steinmetz equation). So it is clear to engineers experienced in these designs, that the grades of steel used in hybrid motors should be based on grades with low thickness and high resistivity, achieved through high compositions of alloy, primarily silicon and aluminum, in order to provide low electrical losses at high frequencies. The requirement for high yield strength comes in addition to the requirement for low electrical losses.

It is usual practice in the prior art, in order to minimize costs, to stamp the rotor and stator from the same steel, using one die and one stamping operation. However, because the requirement for high yield strength is dominant in the rotor, but the requirement for low electrical losses is dominant in the stator, one option is to stamp the rotor and stator from different steels, wherein the combination of high strength and low electrical losses is not achieved simultaneously.

Nippon Steel and Hitachi have successfully developed a prior art electrical steel with yield strength above 600 N/mm² at a thickness of 0.35 mm. This grade, known as 35HS600Y, is the only commercial grade of prior art electrical steel that can achieve this minimum yield strength. However, the technique and strategies used to develop strength are in conflict with the strategies required to develop low electrical losses. As a result, the electrical losses are quite high, typically 5 watts/pound at 1.5 Tesla, 60 Hz (8.7 watts/kg at 1.5 Tesla, 50 Hz). Normal practice for hybrid motors would be to use electrical steel with losses less than 1.45 watts/pound at 1.5 Tesla 60 Hz (2.50 watts/kg at 1.5 Tesla, 50 Hz). There are some electrical loss benefits in the use of this steel which result from the low thickness (0.35 mm) but the benefits are considered minor compared with losses achieved with true low loss electrical steel.

In order to use this steel and capitalize on the high yield strength for use in the rotor, it is necessary to use 2 different grades of steel, one for the rotor (for high strength) and one for the stator (for low electrical losses). This further requires the use and expense of 2 separate dies together with a significant increase in yield loss from stamping since the rotor sector stamped from the stator must be discarded, since it does not have the required high yield strength.

In other prior art, Armco (now AK Steel) has developed the concept of partial annealing for the production of a single alloy group of non-oriented electrical steels, known as semi-processed electrical grades. This concept is used for the production of one grade, M47, in three thicknesses: 0.35 mm, 0.47 mm and 0.65 mm. This grade of steel has normal hardness levels in both the as-shipped condition and after, further annealing after stamping, so there is no recognition that this process may also be used to control yield strength. The composition of M47 has a silicon range of 1.65 to 1.85%.

### Theory of Low Loss Electrical Steel

Losses in electrical steels are described in part by the Steinmetz equation

Total losses are proportional to:

$$\frac{{( \text{frequency} \times \text{thickness induction} )}^{1.6}}{\text{resistivity}}$$

The equation indicates that losses increase by the power or exponent 1.6 as frequency and induction increase. In order to reduce losses, thickness should be decreased and resistivity should be increased. Resistivity may be controlled by a number of factors, the most important of which is chemistry, as shown by the prior art Table of FIG. 1.

This Figure shows that the most important and effective alloying additions to increase resistivity in steel are silicon and aluminum. Phosphorus is also a very effective alloying element to increase resistivity but is limited in scope since steel becomes brittle with the addition of phosphorus at levels above 0.10%. Interestingly, the addition of phosphorus is used and well known for low grade electrical steels because it also increases yield strength and hardness.

### Theory of Control of Yield Strength in Steel

There are three basic principles used to control and increase yield strength in steel: solid solution hardening, interstitial hardening and precipitate formation hardening.

The first principle is notably as follows. Classical metallurgical theory teaches that metals, notably iron, consist of atoms located in a lattice with fixed spacing which is dependent upon the element. When a new or different element is added to the matrix and replaces one of the iron atoms, it will have a different size which will cause the matrix to deform, causing internal stress. If a larger element is added the deformation or stress increases and results in an increase in yield strength. This is known as solid solution hardening since the added element stays in solution as evidenced by the continuity of the matrix without separation of the alloying element to form a new phase. The addition of silicon to iron is a good example of solid solution hardening, as shown in the prior art diagram of FIG. 2.

The second principle is explained as follows. Similar theory teaches that smaller alloying elements may fit between the lattice points but within the overall matrix. This addition does not replace the iron at the fundamental lattice points but still causes a distortion to the lattice, resulting in an increase in yield strength. This mechanism is known as interstitial hardening. The additions of carbon and phosphorus to iron are good examples of interstitial hardening.

The third principle is explained as follows. A third mechanism describes the formation of a precipitate where a separate phase or compound is formed between the element and iron. It is usual practice to control processing so that these precipitates occur at an atomic level such that the lattice undergoes maximum distortion. This is known as precipitate hardening. The most common form of precipitate hardening involves the formation of select carbides within a steel matrix. This is the technique and strategy used by Nippon Steel for the production of the prior art alloy grade 35HS600Y wherein the development of high yield strength is achieved through the formation of a sub-microscopic precipitate of niobium carbide.

The Conflict between Mechanical and Electrical Properties

There is a fundamental conflict between the microstructures of alloys which require low electrical losses and alloys which require high yield and tensile strengths. The microstructure required for low electrical losses in steel requires large grain size, no interruptions to flux transfer or domain rotation such as is caused by precipitates, in any form, and no residual stress. The microstructure required for high yield and tensile strength requires small grain size, the extensive presence of atomic and sub-microscopic precipitates and the presence of residual stress.

Thus, it is evident that the co-existence of both low electrical losses and high yield and tensile strengths is difficult to achieve.

### Production of Electrical Steel

The sequence of processing steps used for the production of electrical steel according to the prior art are illustrated at 9 as in FIG. 3.

With reference to prior art FIG. 3, the following processes are known.

1 Iron Making. A combination of iron ore 10, coke 11 (from coal) and limestone 12 are added to a blast furnace 15. This may be done for ore and limestone via a sinter plant 13 or for coke via a coke plant 14. Hot air is blown into the furnace which initially reacts with the coke to form a mixture of carbon monoxide and carbon dioxide. This gaseous product reacts with the iron ore (iron oxide) to form iron carbon monoxide and carbon dioxide. A bi-product of this process is slag, from the limestone, which is used to remove impurities. The main product is liquid pig iron carried by Torpedo car 16.

2 Steel making. Liquid iron is added via torpedo car 16 to a converter 17 or basic oxygen furnace, together with steel scrap. Oxygen is blown into the mixture and reacts with the carbon and silicon in the pig iron to produce steel (iron with residual elements of carbon, sulfur, phosphorus and other elements). In some situations a separate desulfurization process may be used prior to steel making.

3 Alternative Steelmaking An alternative form of making liquid steel is to melt steel scrap in an electric arc furnace, a practice commonly used by so-called “mini” mills.

4 Vacuum Degassing A critical step in the production of normal high grade electrical steel is the removal of carbon to levels <0.015% by means of a vacuum degasser 18.

5 Ladle Metallurgy Alloying elements are added to the liquid steel to an extent necessary to achieve the final chemistry requirement for the alloy or grade being produced. The ladle metallurgy station having ladle 8 usually has facilities for mixing a liquid steel mixture 8A in the ladle 8 (to ensure uniformity of alloy addition) and for reheating.

6 Continuous Casting. Liquid steel mixture 8A, with the correct alloy additions, is taken in the ladle 8 to a continuous caster 19. The liquid steel exits the bottom of the ladle 8 through a refractory tube into a holding vessel, known as a tundish before exiting the bottom of the tundish through a second refractory tube into a water cooled copper mold. The outer steel freezes to form a solid shell which is slowly removed from the bottom of the mold while the liquid steel continues to solidify. Finally the steel fully solidifies, is bent from a vertical to a horizontal plane, and is cut into sections known as slabs 20.

7 Hot Rolling. The slabs 20 may be cooled prior to reheating. A preferred practice is to “hot-charge” the slabs directly into a reheating furnace at hot strip mill 21 so as to avoid the well-known brittleness that occurs in high silicon alloys. The slabs are heated to a uniform temperature prior to hot rolling, usually involving a combination of so-called “roughing” mills, followed by a connected series of finish rolling stands or mills. For electrical steels, there are critical temperatures required for the slab drop-out temperature prior to hot reduction, the finishing temperature at the end of the finishing stands and the coiling temperature. The final product is a coil of steel, called a “hot band” or hot rolled coil 22 which has a strip thickness typically 1.8 to 2.8 mm.

8 Alternative Hot Rolling There is an alternative form of hot rolling where the continuous caster is coupled directly with the hot strip mill 21 by means of a long tunnel furnace. This technology is applicable to the so-called mini-mills where the slab or bar thickness is 50 to 70 mm compared with a conventional slab thickness of 200 to 250 mm.

9 Pickling. The hot band or hot rolled coil 22 is processed in a pickling station 23 through an acid bath to remove the oxide formed during hot rolling.

10 Hot band Annealing. As shown in FIG. 3 at 230, it is usual practice for high grade low loss electrical steels to be normalized or annealed at high temperatures after pickling. This is usually achieved in a continuous annealing line which may or may not be coupled with the pickle line. This annealing step achieves an important re-orientation of microstructure which results in significantly lower losses and higher permeability for high grade electrical steels. It also provides a softer substrate for feed to the cold mill. This step may be bypassed for lower grade electrical steels

11 Cold Rolling The normalized hot-band is cold rolled, also known as a cold reduction 24, from hot band thickness to final thickness, typically 0.35 mm for low loss electrical steels. Cold rolling may be achieved in single stand reversing mills but is most usually performed in tandem mill where a series of rolling stands, from 2 to 5, are coupled together. Sendzimir mills may also be used for cold reduction

12 Continuous Annealing. The microstructure is massively deformed and stressed during cold rolling. The strip is processed through a continuous annealing line 25 where the cold rolled steel strip is heated to a temperature and for a time, controlled by the line speed, that allows recrystallization and grain growth of the steel. It is also usual practice for the first section of the continuous annealing furnace to be designed to allow decarburization or removal of carbon, to limits <0.005%.

13 Coating After cooling, the annealed strip is processed through a coating head where coating solution is applied by rolls to both sides of the strip. The strip then enters a curing oven to dry and cure the coating. It is usual practice for the coating and curing oven to be fully integrated into the continuous annealing furnace 25 so that the final product is a coated fully annealed electrical steel.

### SUMMARY

It is an object to provide a method for manufacture of electrical steel with high strength and low electrical losses, particularly for a rotor and matching stator of an electric motor.

In a method for manufacture of electrical steel a liquid steel mixture is created with a specified mixture chemistry. A continuous casting is performed to convert the liquid steel mixture to a slab. Hot roll steel band is created from the slab which is then pickled and hot band annealed, and then a cold rolled steel strip is formed. In a continuous annealing, the cold rolled strip is annealed to achieve a partial recrystallization with a smaller grain size than would be the grain size with a complete recrystallization. Electrical steel created by the method is used for rotors and matching stators of a motor:

### BRIEF DESCRIPTION OF THE DRAWINGS

FIG. 1 is a diagram showing control of resistivity for steel based on alloying element weight percent according to the prior art;

FIG. 2 shows a diagram illustrating addition of silicon to iron in making steel as an example of solid solution hardening according to the prior art;

FIG. 3 shows prior art process steps for creation of annealed strip; and

FIG. 4 shows a flow chart of a method according to the preferred embodiment for creating improved electrical steel and improved rotors with matching stators for electric motors combining increased yield strength with relatively low electrical losses.

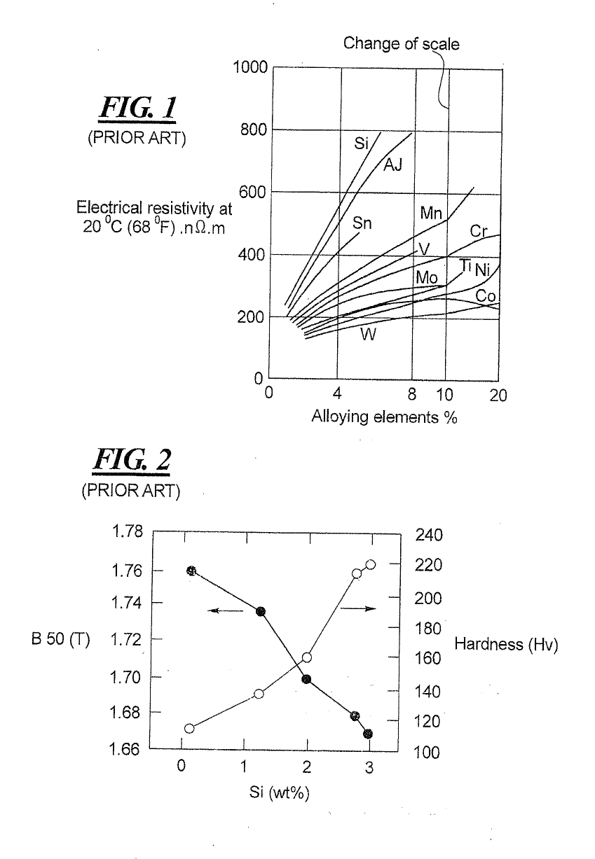

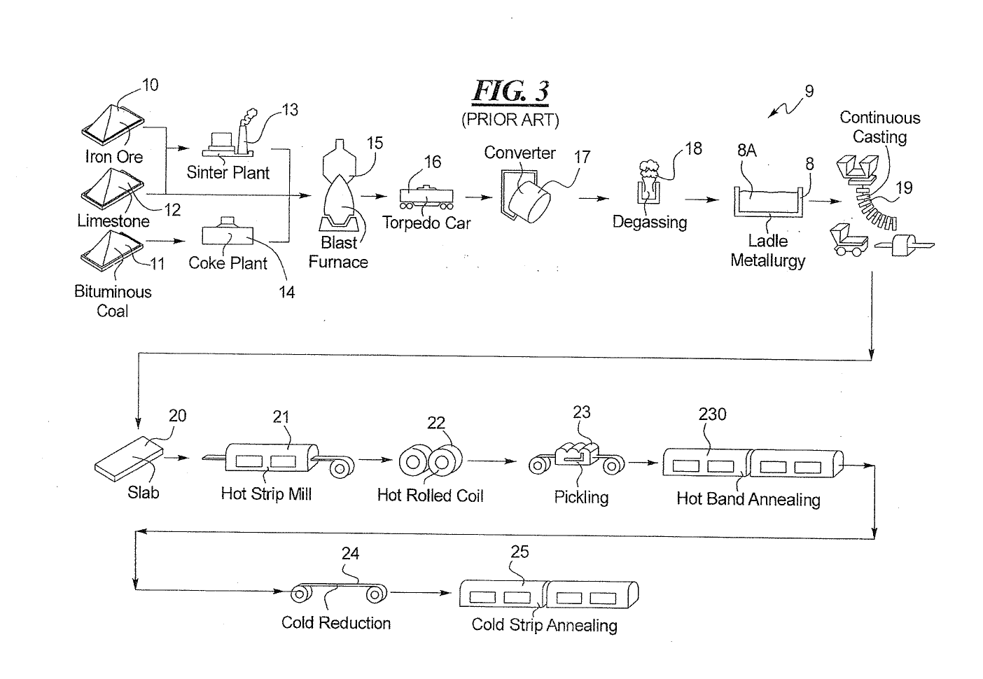

### DESCRIPTION OF THE PREFERRED EMBODIMENT

For the purposes of promoting an understanding of the principles of the invention, reference will now be made to the preferred embodiment/best mode illustrated in the drawings and specific language will be used to describe the same. It will nevertheless be understood that no limitation of the scope of the invention is thereby intended, and such alterations and further modifications in the illustrated device and such further applications of the principles of the invention as illustrated as would normally occur to one skilled in the art to which the invention relates are included.

The preferred embodiment provides this invention a chemistry range for alloys using the addition of elements silicon, aluminum, phosphorus, nickel, chromium and copper. These alloys are processed using normal equipment used for the production of electrical steel. However, the final continuous annealing process is modified so that instead of a full anneal, which would be normal practice to generate full recrystallization and maximum grain growth necessary to achieve low electrical losses, a partial or semi-process anneal is performed which results in recrystallization but with a smaller grain size. Since this annealing process takes place after cold rolling, the steel that is annealed using a semi-process strategy is still stressed. This contributes to higher yield strengths, together with the contributions from the chemical additions. This type of alloy is stamped using one die for both the rotor and the matching stator. However, after stamping, the stators are further annealed to remove stress and achieve lowest electrical losses while the rotors are used in the stressed condition, providing high yield strength and low, but not the lowest, electrical losses.

The method of the preferred embodiment uses the equipment and general process sequences known for the production of low loss electrical steel, but with the following modifications or adjustments.

The method comprises two parts.

Part 1 Control of Chemistry

The range of final chemistry used for the production of conventional low loss electrical steels is as follows (% by weight):

| | | |
|---|---|---|
| Carbon | <0.005% | |
| Manganese | 0.10 to 0.35% | |
| Phosphorus | <0.040% | |
| Sulfur | <0.005% | (and preferably <0.002%) |
| Silicon | 2.8 to 3.3% | |
| Aluminum | 0.35 to 1.6% | |

With the exception of carbon, the chemistry is achieved by the appropriate addition of alloying elements at the ladle metallurgy station. No change is proposed in this process sequence.

Theory teaches that best microstructures for low loss electrical steel are achieved with large uniform grains without the formation of precipitates. Theory also teaches that hardening or increase in yield strength may be achieved through the addition of elements which stay in solid solution. However, for the preferred embodiment method, the strategy for formation of precipitates to increase yield strength is not used and the following composition range is employed for the preferred embodiment method (% by weight):

| | |
|---|---|
| Carbon | <0.015% |
| Manganese | 0.10 to 0.35% |
| Phosphorus | <0.080% |
| Sulfur | <0.005% |
| Silicon | 2.8 to 3.3% |
| Nickel | <6.0% |
| Chromium | <1.0% |
| Copper | <0.10% |
| Aluminum | 0.35 to 1.6% |

The specific addition of nickel is identified together with smaller additions of chromium and copper for the purpose of increasing solid solution hardness. Nickel has the added advantage of being partially ferro-magnetic.

The use of nickel in iron-nickel alloys is well known for a limited range of electrical steels (so-called “High Permeability Alloys”) but is unknown when used in conjunction with significant silicon and aluminum additions for non-oriented silicon electrical steels.

The use of very small additions of chromium and copper is well known for the production of certain grades of semi-processed electrical steel (most usually as contamination from similar production of stainless steels) and for the production of certain grades of grain oriented electrical steel. However, the use of small additions of chromium and copper in conjunction with a larger addition of nickel is unknown.

It is apparent that the wide range of nickel additions together with other alloying elements leads to the generation of a number of different alloys, all of which form the basis of the preferred embodiment method.

Part 2 Continuous Annealing Process

No change is proposed for the use of the process sequence step known as continuous annealing.

The usual continuous annealing process involves line speeds between 50 and 70 m/minute with the objective of achieving full recrystallization and some grain growth. The actual line speed depends on the length of the furnace (in order to achieve a specific time at temperature) and on the strategy selected for decarburization (which depends on a combination of vacuum degassing and continuous annealing decarburization capabilities).

The preferred embodiment includes a modification to the continuous anneal process where a faster speed is used compared to full anneal for the achievement of full recrystallization. A small increase in annealing temperature may or may not be used in combination with the increase in line speed. The objective of the increased line speed is to achieve a minimum recrystallization without grain growth and leave the steel partially stressed, a condition and process sometimes referred to as “semi-processed”. Using this process modification, reduction in line speed to achieve critical decarburization to limits <0.005% is no longer essential since the stators will receive a final decarburization anneal after stamping.

No change is proposed to the coating process which would normally be incorporated as the last section of the continuous annealing line.

The resulting semi-processed electrical steel will demonstrate electrical properties that require a further anneal for the stator after stamping to achieve optimum low losses. The rotor will exhibit high yield strength and good electrical properties. It has already been demonstrated that hybrid motors may operate using high electrical loss in the rotor. (refer to the Nippon grade 35HS600Y) whereas the rotors stamped from the present preferred embodiment show a combination of high strength and good electrical properties.

With the preferred embodiment method, the specified chemistry and modified continuous annealing for partial recrystallization is employed to produce a series of low loss electrical steel alloy grades exhibiting yield strengths above 550 Nmm2 in combination with electrical losses below 2.00 watts/pound at 1.5 Tesla at 60 Hz (3.5 watts/kg at 1.5 Tesla, 50 Hz). By way of comparison, the range of yield strengths for normal low loss electrical steel processed under full anneal conditions is 400 to 450 N/mm2, depending upon the alloy composition.

Also with the preferred embodiment method, the partial recrystallization annealing step can be followed by a simultaneous stamping of rotors with high strength and matching stators with low losses using one production stamping tool, followed by a further anneal of the stator to minimize electrical losses therein which are preferably below 1.45 watts/pound at 1.5 Tesla at 60 Hz (2.50 watts/kg at 1.5 Tesla, 50 Hz).

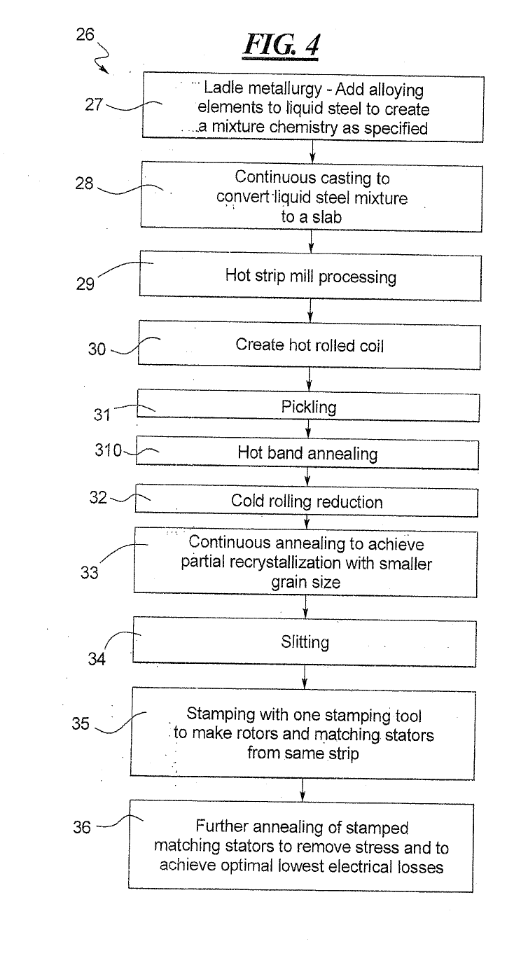

The steps of the preferred embodiment method are shown in the flowchart 26 in FIG. 4.

In step 27, ladle metallurgy is used to create a liquid steel mixture having the mixture chemistry as specified above. This liquid steel is then fed to a continuous casting station in step 28 to convert the liquid steel mixture to a slab. The slab is then fed to a hot strip mill at step 29. Hot strip from the hot strip mill is then used in step 30 to create hot rolled coil. Thereafter in step 31a pickling is performed on the hot roll coil, followed by a hot band annealing at step 310. Then a cold rolling reduction occurs at step 32.

A cold rolled coil is then fed in step 33 to a continuous annealing facility to achieve partial recrystallization with a smaller grain size than would otherwise occur given a full recrystallization.

A partially recrystallized strip is then slit at step 34 in a slitting station.

In Step 35, the slit strip is stamped with one stamping tool to make rotors and matching stators from the same strip.

In a further annealing at step 36, the stamped matching stators are further annealed to remove stress and achieve lower electrical losses, and preferably optimum lowest electrical losses.

While a preferred embodiment has been illustrated and described in detail in the drawings and foregoing description, the same is to be considered as illustrative and not restrictive in character, it being understood that only the preferred embodiment has been shown and described and that all changes and modifications that come within the spirit of the invention both now or in the future are desired to be protected.

1. A method for manufacture of electrical steel, comprising the steps of:
in a mixing process creating a liquid steel mixture by adding to previously created liquid steel chromium, copper, and nickel for increasing solid solution hardness in said electrical steel in solid form being manufactured, said nickel also contributing to a ferromagnetic property of said electrical steel, said elements being added having the following weight percents

| | |
|---|---|
| chromium | <1.0% |
| copper | <0.10% |
| nickel | <6.0%; |

performing a continuous casting to convert the liquid steel mixture to a slab;
creating hot rolled steel band from the slab and pickling to create a pickled band;
hot band annealing the pickled band;
performing a cold rolling reduction of the annealed pickled band to create a cold rolled strip; and
in a continuous annealing process, annealing the cold rolled strip to achieve a partial recrystallization with smaller grain size than would be the grain size given a complete recrystallization to provide said electrical steel being manufactured.

2. The method of claim 1 wherein a feed speed of the cold rolled strip in the continuous annealing process is a faster speed than would be a speed used for a full anneal for achievement of full recrystallization.

3. The method of claim 1 wherein the electrical steel has a yield strength above 550 N//mm² and an electrical loss below 2.0 watts/pound at 1.5 Tesla at 60 Hz which corresponds to 3.5/kg at 1.5 Tesla at 50 Hz.

4. The method of claim 3 wherein the annealed electrical steel with partial recrystallization is stamped and parts resulting from the stamping are then further annealed to remove stress and achieve a lower electrical loss.

5. The method of claim 4 wherein the lower electrical loss achieved for the stamped parts is below 1.45 watts/pound at 1.5 Tesla at 60 Hz which corresponds to 2.50 watts/kg at 1.5 Tesla at 50 Hz.

6. The method of claim 4 wherein the electrical losses are optimized to a lowest level by said further annealing after the stamping of the parts.

7. The method of claim 1 wherein said continuous annealing step produces said partial recrystallization by utilizing a higher line speed than would be used for recrystallization and wherein said smaller grain size results than would be the case given said full recrystallization since no grain size growth occurs during said partial recrystallization.

8. A method for manufacture of electrical steel, comprising the steps of:
in a ladle metallurgy process, creating a liquid steel mixture comprising the following elements by weight percent

| | |
|---|---|
| Carbon | <0.015% |
| Manganese | 0.10 to 0.35% |
| Phosphorus | <0.080% |
| Sulfur | <0.005% |
| Silicon | 2.8 to 3.3% |
| Nickel | <6.0% |
| Chromium | <1.0% |
| Copper | <0.10% |
| Aluminum | 0.35 to 1.6% |

performing a continuous casting to convert the liquid steel mixture to a slab;
creating hot rolled steel band from the slab and pickling;
hot band annealing the pickled band;
performing a cold rolling reduction of the annealed pickled band to create a cold rolled strip; and
in a continuous annealing process, annealing the cold rolled strip to achieve a partial recrystallization with smaller grain size than would be the grain size given a full recrystallization.

9. A method for manufacture of rotors and matching stators of electrical steel for a motor, comprising the steps of:
in a mixing process creating a liquid steel mixture by adding to previously created liquid steel chromium, copper, and nickel for increasing solid solution hardness in the electrical steel in solid form being manufactured, said nickel also contributing to a ferromagnetic property of said manufactured electrical steel, said elements being added having the following weight percents

| | |
|---|---|
| chromium | <1.0% |
| copper | <0.10% |
| nickel | <6.0%; |

performing a continuous casting to convert the liquid steel mixture to a slab;
creating hot rolled steel band from the slab and pickling;
performing a cold rolling reduction of the annealed pickled band to create a cold rolled strip;
in a continuous annealing process, annealing the cold rolled strip to achieve a partial recrystallization with smaller grain size than would be the grain size given a complete recrystallization,
slitting a strip from the continuous annealing process to create slit strips;
feeding at least one of the slit strips to one stamping tool which performs a stamping to make both rotors and the matching stators for the motor from the same strip; and
performing a further annealing of the stamped matching stators to remove stress and achieve lower electrical losses.

10. The method of claim 9 wherein a feed speed of the cold rolled strip in the continuous annealing process is a faster speed than would be a speed used for a full anneal for achievement of full recrystallization.

11. The method of claim 9 wherein the electrical steel of the rotors has a yield strength above 550 N/mm² and an electrical loss below 2.0 watts/pound at 1.5 Tesla at 60 Hz which corresponds to 3.5 watts/kg at 1.5 Tesla at 50 Hz.

12. The method of claim 9 wherein the further annealed stators have an electrical loss below 1.45 watts/pound at 1.5 Tesla at 60 Hz which corresponds to 2.5 watts/kg at 1.5 Tesla at 50 Hz.

13. The method of claim 9 wherein the lower electrical losses of the stators are optimized for lowest electrical losses.

14. The method of claim 9 wherein said continuous annealing step produces said partial recrystallization by utilizing a higher line speed than would be used for recrystallization and wherein said smaller grain size results than would be the case given said full recrystallization since no grain size growth occurs during said partial recrystallization.

15. A method for manufacture of rotors and matching stators of electrical steel for a motor, comprising the steps of:
in a ladle metallurgy process, creating a liquid steel mixture comprising the following elements by weight percent

| | |
|---|---|
| Carbon | <0.015% |
| Manganese | 0.10 to 0.35% |
| Phosphorus | <0.080% |
| Sulfur | <0.005% |
| Silicon | 2.8 to 3.3% |
| Nickel | <6.0% |
| Chromium | <1.0% |
| Copper | <0.10% |
| Aluminum | 0.35 to 1.6% |

performing a continuous casting to convert the liquid steel mixture to a slab;
creating hot rolled steel band from the slab and pickling to create a pickled band;
hot band annealing the pickled band;
performing a cold rolling reduction of the annealed pickled band to create a cold rolled strip;
in a continuous annealing process, annealing the cold rolled strip to achieve a partial recrystallization with smaller grain size than would be the grain size given a full recrystallization;
slitting a strip from the continuous annealing process to create slit strips;
feeding at least one of the slit strips to one stamping tool which performs a stamping to make both rotors and the matching stators for the motor from the same strip; and
performing a further annealing of the stamped matching stators to remove stress and achieve lower electrical losses.

16. An electrical steel, comprising'
a mixture of elements comprising at least the following elements by weight percent

| | |
|---|---|
| Chromium | <1.0% |
| Copper | <0.10% |
| Nickel | <6.0%; |

said electrical steel having a partial recrystallization with smaller grain size than would be the grain size given a complete recrystallization; and
said electrical steel having a yield strength above 550 N/mm² and an electrical loss below 2.0 watts/pound at 1.5 Tesla at 60 Hz which corresponds to 3.5 watts/kg at 1.5 Tesla at 50 Hz.

17. The electrical steel of claim 16 wherein in addition to said chromium, copper, and nickel, said electrical steel has at least the following additional elements:

| | |
|---|---|
| Carbon | <0.015% |
| Manganese | 0.10 to 0.35% |
| Phosphorus | <0.080% |
| Sulfur | <0.005% |
| Silicon | 2.8 to 3.3% |
| Aluminum | 0.35 to 1.6% |

18. An electric motor, comprising:
a rotor comprised of a plurality of laminations and a matching stator for the motor comprising a plurality of laminations;
the rotor and the stator laminations being formed from an electrical steel having a same mixture of elements and weight percents of those elements;
the rotor laminations having a partial recrystallization and a yield strength above 550 N/mm² and an electrical loss below 2.0 watts/pound at 1.5 Tesla at 60 Hz which corresponds to 3.5 watts/kg at 1.5 Tesla at 50 Hz; and
the matching stator laminations having an increased recrystallization compared to the rotor laminations, and having an electrical loss below 1.45 watts/pound at 1.5 Tesla at 60 Hz which corresponds to 2.50 watts/kg at 1.5 Tesla at 50 Hz.

19. The motor of claim 18 wherein said mixture of elements and weight percents is as follows:

| | |
|---|---|
| Carbon | <0.015% |
| Manganese | 0.10 to 0.35% |
| Phosphorus | <0.080% |
| Sulfur | <0.005% |
| Silicon | 2.8 to 3.3% |
| Nickel | <6.0% |
| Chromium | <1.0% |
| Copper | <0.10% |
| Aluminum | 0.35 to 1.6% |

20. The electric motor of claim 18 wherein said electrical steel mixture of elements has at least the following elements and weight percents:

| | |
|---|---|
| chromium | <1.0% |
| copper | <0.10% |
| nickel | <6.0%; |

21. A method for manufacture of electrical steel, comprising the steps of:
in a mixing process creating a liquid steel mixture;
performing a continuous casting to convert the liquid steel mixture to a slab;
creating hot rolled steel band from the slab and pickling to create a pickled band;
hot band annealing the pickled band;
performing a cold rolling reduction of the annealed pickled band to create a cold rolled strip; and
in a continuous annealing process, annealing the cold rolled strip to achieve a partial recrystallization with smaller grain size than would be the grain size given a complete recrystallization to provide said electrical steel being manufactured.

22. An electrical steel, comprising:
a mixture of elements;
said electrical steel having a partial recrystallization with smaller grain size than would be the grain size given a complete recrystallization; and
said electrical steel having a yield strength above 550 N/mm² and an electrical loss below 2.0 watts/pound at 1.5 Tesla at 60 Hz which corresponds to 3.5 watts/kg at 1.5 Tesla at 50 Hz.
